(19) United States
(12) Patent Application Publication
(10) Pub. No.: US 2018/0126597 A1
(43) Pub. Date: May 10, 2018

(54) EXTRUDER ARRANGEMENT AND A METHOD OF FEEDING FEED MATERIAL INTO AN EXTRUDER

(71) Applicant: Harald RUST, Bochum (DE)

(72) Inventor: Harald RUST, Bochum (DE)

(21) Appl. No.: 15/665,847

(22) Filed: Aug. 1, 2017

Related U.S. Application Data
(63) Continuation-in-part of application No. PCT/EP2016/000077, filed on Jan. 17, 2016.

(30) Foreign Application Priority Data
Feb. 2, 2015 (DE) 102015001167
Feb. 7, 2017 (DE) 102017001093

(51) Int. Cl. B29B 7/84; B29B 7/60; B29B 7/48; B29B 7/82; B01D 46/12; B01D 46/00; B01D 46/42

(52) U.S. Cl. CPC B29B 7/84; B29B 7/60; B29B 7/48; B29B 7/823; B01D 46/12; B01D 2275/202; B01D 46/4263; B01D 46/0068; B01D 2275/10; B01D 2279/35; B01D 46/0005

(57) ABSTRACT

An extruder arrangement and a method of feeding feed material into an extruder. The abstract of the disclosure is submitted herewith as required by 37 C.F.R. § 1.72(b). As stated in 37 C.F.R. § 1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2016/000077, filed on Jan. 17, 2016, which claims priority from Federal Republic of Germany Patent Application No. 10 2015 001 167.7, filed on Feb. 2, 2015. International Patent Application No. PCT/EP2016/000077 was pending as of the filing date of this application. The United States was an elected state in International Patent Application No. PCT/EP2016/000077. This application also claims priority from Federal Republic of Germany Patent Application No. 10 2017 001 093, filed on Feb. 7, 2017.

### BACKGROUND

### 1. Technical Field

The present application relates to an extruder arrangement and a method of feeding feed material into an extruder.

### 2. Background Information

Background information is for informational purposes only and does not necessarily admit that subsequently mentioned information and publications are prior art.

The present application relates to extruders for mixing and extruding feed materials. Extruders are differentiated into the following main groups: single screw extruders, twin screw extruders, planetary roller extruders.

Single screw extruders comprise a rotating screw and a surrounding housing. Single screw extruders can achieve a high pressure build-up and a significant conveying effect. However, the homogenization and dispersion of feed materials is poor in the single screw extruder. Nonetheless, single screw extruders are still the most widely used extruders.

Twin screw extruders comprise two intermeshing and parallel screws and a surrounding housing. Twin screw extruders can also achieve a high pressure build-up and a significant conveying effect. The mixing effect of the twin screw extruder is much greater than that of a single screw extruder. However, due to the mechanical stress in the twin screw extruder, plastics undergo a more or less extensive modification of their molecular chains. There are applications for which this is irrelevant. In other applications, the retention of the molecular chains is important, and a planetary roller extruder (PRE) lends itself to this.

Planetary roller extruders comprise multiple parts, such as a rotating central spindle, a housing that surrounds the central spindle at a distance and has an inner toothing, and planetary spindles that rotate in the cavity between the central spindle and the inner toothed housing like planets rotating about the central spindle. Hereinafter, when an inner toothing is mentioned, then this also includes a multi-part housing with a sleeve that forms the inner toothing of the housing. In the planetary roller extruder, the planetary spindles mesh with both the central spindle as well as with the inner-toothed housing. At the same time the planetary spindles slide with the end pointing in the conveying direction on a thrust ring.

In comparison to all other extruders, the planetary roller extruders exhibit an extremely good mixing action, but with a much lower conveying action.

Some planetary roller extruders are used for the continuous processing of plastics.

Some planetary roller extruders are composed of sections and/or modules, which terms can be used interchangeably herein to refer to the sections or modules of a planetary roller extruder. Often the sections or modules are different in design or configuration. Over the years, planetary roller extruder sections or modules combined with differently designed sections or modules have proved helpful. For example, planetary roller extruder sections or modules can often be combined with a feed section designed as a single screw extruder section or module. Extrusion feedstocks are fed from a feed hopper through the feed section and pressed into the downstream planetary roller extruder sections or modules in order to be processed therein.

Insofar as liquid blowing agents or other liquids are intended to be incorporated into the planetary roller extruder sections or modules, it has proved helpful to inject these liquids into the unit through injection rings that are arranged between each two planetary roller extruder sections or modules.

Some designs incorporate melts through a sidearm extruder or pump directly into a planetary roller extruder section or module.

Besides plastics, still other diverse materials may be extruded. These include fillers, colorants, plasticizers, stabilizers, and other additives and auxiliaries. All the substances will be denoted hereinafter as feedstocks or feed materials. The feedstocks may be in solid form or in liquid form or in gaseous form.

For all extruder designs, one differentiates between the feed zone, the transition zone, the mixing zone and the metering zone. Still other differences are also possible.

With current extruders, one extruder module is usually arranged for each zone. This means that these extruders are composed of modules. The modules are identifiable on a housing that is matched to the relevant section. Each housing is equipped with a flange on each end, such that each housing can be connected on a flange with its adjacent housing. The housings that are fastened together usually surround screws or central spindles that extend through all the modules. This means that the single screw extruder, composed of modules, possesses a single screw that extends through all modules. The twin screw extruders, composed of modules, possess intermeshing screws that extend through all modules. The planetary roller extruders possess a central spindle that extends through all modules. In contrast, the planetary spindles are limited to the individual modules.

Extruders of a mixed design are in particular those that combine planetary roller extruder modules with feed sections that are designed as single screw extruders. For this type of extruder design as well there is provided a component which extends through the complete housing. This component forms the central spindle in the zone of the planetary roller extruder modules, and the single screw in the zone of the feed section. All modules are generally of the same length. This can lead to overlapping zones.

The feedstock to be processed in the extruder may have different consistencies. The plastic may consist of solid particles. The plastic particles are mostly in granular form. The plastic may, however, be supplied in powder form or also as a melt. Other feedstocks are generally employed as fine grains, powders or even as dust. For example, powdered chalk as a filler or a powdered cell builder is often processed for the production of foam.

Granular feedstocks are usually free-flowing and can be metered with a feed hopper into the feed zone of the extruder. The feed hopper is supplied from a silo. The granular feedstocks are mainly transported in bags. Bags are oversized bags/sacks that are emptied from above the silo into the silo. Alternatively, cardboard cartons with a plastic lining may also be used. Containers and other shipping tanks may also be used to transport the granular feedstocks. In such cases the containers do not necessarily have to be placed above the silos. The containers may also be emptied onto a conveyor belt or another lifting conveyor which brings the feedstock above the inlet opening of the silo.

Powdered feedstocks behave differently from a granular feedstock. Dusty feedstocks are even more difficult. Although the powdery and dusty feedstocks are also stocked in silos, usually air is used to fill the silos or to transport these feedstocks into an extruder. The finely ground feedstocks are both carried into the silos with air and conveyed out of the silos into the extruder. Usually efforts are made in the feed zone to prevent air from being drawn into the extruder with the feedstock.

According to some methods, air can be separated from the feedstock, such as when feedstock for PVC products is filled into an injection molding machine. However, it may not be clear how such feedstock is brought into an injectable form in the injection molding machine. The feedstock comprises fresh PVC and recycled PVC. The feedstock is so fine that it can be transported with air by means of a suitable conduit through a hopper for the injection molding machine. The hopper is located above the inlet opening of the injection molding machine. The air is stripped from the conduit in the hopper. A filter should cause the finely ground PVC to remain in the hopper and feed into the inlet opening of the injection molding machine. The filter is located at the head of the hopper. In this system the air is inadequately separated from the PVC. Consequently, significant quantities of air enter with the PVC into the injection molding machine. Any degassing of the injection melt is not recognized or apparently disclosed. The resulting PVC injection parts can therefore only have an average to poor quality.

In the above method, one filter disk is used. However, dusty feedstock very quickly clogs the filter, and thus the filter disk should be cleaned. Two filter disks can be provided instead of a single filter disk. Both filter disks can be operated differently, such that one filter disk can be utilized to maintain the filtering operation, while the other filter disk is being cleaned and vice versa.

In a different approach for feeding plastic processing devices with feedstock, there can be arranged, above the inlet opening of an extruder, a plurality of containers that are connected together to form a multi-chamber system. The top container is initially filled with the feedstock. The container is then closed and partially evacuated. This means that the air is partially removed. After evacuation, the container is opened underneath and, while maintaining the obtained evacuation state, the feedstock is transferred into the container located below. Another evacuation is carried out there. During the transfer and maintenance of the evacuation state in the upper container, the lower container—up to the opening for the material transfer—is hermetically connected with the upper container and closed off from the extruder. After the upper container has been emptied into the lower container, the inlet opening of the lower container, which also serves as the outlet opening of the upper container, is closed again. The evacuation can be continued in the lower container that is sealed on all sides. After the desired evacuation state has been reached, the outlet opening of the lower container, which is simultaneously the inlet opening of the extruder, is opened and the feedstock is allowed into the extruder. As the evacuation is being carried out in the lower container, the top of the upper container is opened, such that additional feedstock can flow in. After the upper container has been closed, it is again evacuated.

The described operation of the containers is an intermittent operation. This intermittent operation mode of the containers is disadvantageous for an extruder that is designed for a continuous or substantially continuous material feed.

If the air is not completely separated from the feedstock then the air must be removed at a later time. The problem associated with air removal or the removal of other carrier gases becomes particularly serious when finely ground or dusty feedstocks are intended to be conveyed with air or carrier gas and supplied into the extruder.

The gas entrained in the feed zone is not the only gas to be removed. During the processing of the feedstock, it is very often the case that gases are generated in the extruder and have to be removed from the melt through degassing procedures.

The degassing process ensures that after the plastic has melted, entrained air, together with other gases generated during extrusion, are stripped out of the melt. To execute the degassing, a reduced pressure is created at a desired location in the extruder or in the melt. At this position the enclosed gas completely or partially escapes out of the melt. The escaping gas is given the possibility to escape from the extruder through an opening in the extruder housing. Degassing domes located above the extruder housing may be used. Any melt entrained with the gas out of the extruder can be collected underneath.

As a result of impacts on the degassing point, the danger associated with the entrainment is particularly great for the usual degassing support.

In some extruders, such as a twin screw extruder, a gas-permeable wall made of sintered material is used in order to promote optimum operation when the extruder is only partially-filled, and therefore has substantially less pressure, during feeding of powdery and dusty bulk materials. In such an extruder, a layer of powdery bulk material is created on the gas-permeable wall portion by applying a low pressure without extracting any of the powdery bulk material. Additional procedures due to an unwanted discharge of bulk material are not required. The layer of bulk material can increase wall friction and improve the transport, or conveyance, of the bulk material. Degassing of the bulk material that is transported as a solid in the partially-filled inlet zone can be formed. Thus, there is no significant degassing occurring through the gas-permeable wall portion. There is no clogging of the wall of the porous wall portion facing the bore due to plasticized material adhering thereto. There is no active extraction of air through the porous wall portion during the entire processing process.

It follows that the gas-permeable wall section in no way serves the degassing by extracting air. In this respect the gas-permeable section of the extruder provided for processing the plastic has no filter function. The reduced pressure on the wall section is only intended to ensure that powdery feedstock is deposited on the inner side of the wall section.

In another extruder, the porous wall made of sinter material may utilize a metal fleece instead of the sinter material.

One significant drawback of the above extruders with porous or gas-permeable walls is the need to maintain a specific degree of filling. Failure to comply with the specific degree of filling brings about disruptions to the process.

### OBJECT OR OBJECTS

An object of this application is to facilitate the separation of air from solid materials in an extruder.

### SUMMARY

In this regard the application again turns towards the technology described above, according to which the solid materials should be separated from the air before the solid material enters into the extruder. According to one exemplification, the object can be achieved in an extruder for processing feedstock, wherein the extruder possesses a housing designed for a single screw extruder or a planetary roller extruder, into which housing the feedstock is fed. Alternatively the extruder comprises at least two sections, wherein one section is designed as a single screw extruder, and another section is designed as a planetary roller extruder. The single screw extruder section receives the feedstock, and the planetary roller extruder section is disposed downstream and is at least involved in the further processing of the feedstock. Prior to entering into the extruder, the feedstock is subjected to an at least partial separation of the solids from the carrier gas, wherein a filter that is seated in the line or in a supply housing is used for the separation. Depending on the filter design, more than 50%, or more than 70%, or more than 80%, or more than 90% of the carrier gas, due to a pressure drop at the filter, escapes through the filter. The filter used is composed of at least two porous filter disks that exhibit a mean diameter of 10 to 50 mm, or a mean diameter of 20 to 40 mm. The various filter disks are uniformly or essentially uniformly or substantially uniformly distributed on the periphery of the line or of the supply housing. The filter disks can comprise a sinter material. Due to the use of the filter, the remaining carrier gas together with other gases that are released during the extrusion in the extruder are stripped away. Other exemplifications and features thereof are disclosed herein.

According to one possible exemplification, the filter is designed such that, before or as the feedstock is being filled, as much gas as possible is extracted, such as, at least 50%, at least 70%, at least 80%, and at least 90%. This applies when filling finely divided or powdery or dusty feedstocks that are conveyed to the extruder with air or gas. The extraction of the air/gas affords a significantly greater material feed into the extruder.

The extraction of the air/gas prior to the material feed may also lead to a significant increase in the quality of the extrudate (of the product produced by processing in the extruder). This is evident, for example, for adhesive mixtures that react in undesirable ways in contact with air. This also applies to other materials that react in undesirable ways with air and other gases. According to one possible exemplification, the feedstocks, entrained with the air or gas, are filtered off.

Some twin screw extruders are equipped with a degassing orifice. The degassing orifice is sealed with a porous, gas-permeable sinter plate. The sinter plate is matched to the contour of the extruder housing inner wall and set back from the inner wall of the extruder housing. The dimensions of the plate may be, for example, 80 square centimeters. In such a twin-screw extruder an uninterrupted degassing operation is possible for a set period of time, such as two days. One concern is that the feedstock could scorch on the porous filter layer, which can be formed by sinter plates as the filter layers for degassing. These sinter plates that serve as filter layers are matched to the housing shape.

At least one exemplification of the present application differs from the preceding example in the layout of the filter surfaces and in the possibility to use simpler porous filter disks. At least two filter surfaces are provided instead of a single filter surface. According to the exemplification, from one filter surface at least two smaller, identical filter surfaces are formed. The required total filter surface is composed of identical smaller filter surfaces. The smaller the filter surface the easier it is with identical filter disks to make up different filter surfaces, even differently curved filter surfaces. Curved filter surfaces may also be made up from flat filter disks.

The filter surfaces may also be made up from different filter disks. In this regard, the filter disks may be angular and/or round. A circular or oval or a square or rectangular or hexagonal shape is preferably provided. The square or rectangular filter disks can be made up into particularly compact filter surfaces. The circular filter disks offer advantages in the flow technology and for cleaning. Hexagonal filter disks permit a honeycomb composition of the filter surfaces.

The proportional reduction of circular sinter disks results in smaller circular sinter disks; the proportional reduction of square sinter disks results in smaller square sinter disks; the proportional reduction of rectangular sinter disks results in smaller rectangular sinter disk-shaving lengths and widths, which are in the same ratio as the lengths and widths of the larger rectangular sinter disks.

The division with reductions may also involve disproportional reductions. A disproportional reduction may create another shape. For example, a square filter surface may be divided up into a plurality of rectangular filter surfaces. A plurality of variously shaped filter surfaces may be created by the division. The smaller filter surfaces can replace the single large filter surface.

With existing filter surfaces the filter can be converted, such that a plurality of smaller filter surfaces replaces the single large filter surface. However, the user must not ignore the evident costs of the conversion. A user decides only when it is clear which advantages would be brought by the conversion costs, such as is disclosed herein. When constructing a new filter it should be initially clarified which total filter surface is required.

The total filter surface is calculated from the capacity of a filter and from the quantity of material to be filtered out of the air or another gas, and also from the quantity of air or gas as well as the purity of the exiting air or gas. Usually, the desired service life is also a criterion for the design of the filter. The service life is considered here as the time in which a filter is functional with a desired efficiency without intermediate cleaning. This design is carried out in a conventional manner. The result is a designed filter surface.

According to one possible exemplification, the designed filter surface is used, in that the filter surface is formed from a plurality of filter surfaces.

According to one possible exemplification, the smaller filter surfaces together form the same filter surface as a single large filter surface or designed filter surface or form a somewhat smaller filter surface or a somewhat larger filter surface. The deviation from the single large filter surface or from the designed filter surface is a maximum of 30%, or a maximum of 20%, or a maximum of 10%.

The division of the filter surfaces provides several advantages. First, the same filter disks can be used for various extruder sizes. This reduces the production costs and maintenance costs. The larger the production series, the greater the price is reduced, because time is saved on order management, setup time is saved, and more sinter material can be procured at a more favorable price. In addition, the smaller filter disks can be thinner than the larger filter disks, because smaller filter disks, due to their dimensions, are less liable to fracture than larger filter disks.

The technical effort involved in assembling a plurality of smaller filter surfaces is indeed greater than assembling a larger filter surface. However, this is more than offset by the resulting advantages.

The application discloses advantages when solely or essentially solely or substantially solely the carrier gas, due to its pressure, flows through the filter and thereby separates the carrier gas from the feedstocks for the extruder. An induced draft is additionally applied on the discharge side of the filters. The induced draft can be brought about with various devices. In the simplest case it can be a fan. The fan is suitable for slightly reduced pressures. In principle, all compressors may also be used to generate the induced draft. Each compressor has a discharge side and a suction side.

A liquid ring pump may be used for a larger negative pressure.

According to at least one exemplification, the filtering out of particles may afford an extremely efficient separation of air or carrier gas from the solid particles. Depending on the applied induced draft, the solid particles may even be suitably compressed such that they can be fed into the extruder.

Not only fine-grained particles but also dusty solid particles, which are prone to electrostatic charging and mutual repulsion, can be processed well with the process according to one possible exemplification.

Fibrous particles may also be processed with the process according to one possible exemplification.

The process according to one possible exemplification lends itself for processing all bulk materials that have a low bulk density when loosely filled. This applies to bulk densities of less than 1 g/cm³. Exemplary feedstocks of this type may be: Aerosil, pyrogenic silica with a bulk density of about 0.05 g/cm³; powder coating materials, suction fractions with a bulk density of about 0.4 g/cm³; powdered rubber, recycled tires with a bulk density of about 0.5 g/cm³; and all finely grained, powdered or dusty materials

The feedstock can include not only finely grained/powdered and dusty solid particles, but also granular solid particles and fibrous particles and the like.

The use of air extraction is of advantage for bulk material that is fed with minimal to no problem from a hopper into the extruder.

In this respect, the degree of the subsequently provided degassing can thus be significantly reduced in order to obtain the same product quality. With a subsequent unchanged degassing of the melt, the suction of the air/gas prior to the material entry results in an overall better degassing and a better product quality.

The filter disks are optionally matched to the associated housing.

For the housings for the inlet of finely grained and dusty feedstocks, the feedstocks are fed to the housing by air or by another carrier gas through a pipe or tubular line.

Tubular housings may be used which are shortened or lengthened to match the desired filter performance. The housings may also have a modular design, such that a plurality of shorter housings with a given number of filter disks can be fitted together and increase the filter performance according to the number of filter disks. The filter performance can be correspondingly reduced by disassembling individual housing modules. The assembly and disassembly is optionally facilitated by equipping the ends of the housings of the housing modules with collars, wherein the modules are connected by clamping the housings at their collars. Screws and nuts may be used for clamping.

The housing may also include one or more screws that have the task of removing the material deposited on the filter disks and feeding the material to the extruder. In this regard, the deposited material may be removed as far as down to the surface of the filter disks or a defined material layer is produced, which ensures or promotes a consistent filter performance over the long term.

When the supply housing is lengthened or shortened or the above-described filter surface is reduced or enlarged, then screws are employed with a matching length.

Housings with bores are mainly used whose diameter is matched to the screws. This results in a round/curved inner wall of the housing.

With round inner walls of the housing the filter disks can be flat or curved. The curvature can be equal to the curvature of the inner wall of the housing. The filter disks can then be fitted flush into a suction opening in the housing wall, such that the filter disks seal the housing wall at the suction opening in such a manner as if a uniform housing wall existed.

The filter disks are optionally also set back somewhat from the inner wall of the housing wall. It may be advantageous if: the extent of the offset is adjustable; the material to be filtered off is deposited in front of the filter disk; and/or the thickness of the deposited material is determined by the screw.

The thickness of the material on the filter disks can then be determined by the offset of the filter disk. This can be utilized in one possible exemplification to optimize the thickness of the deposited material layer. The filter disks can be adjusted in a stepless or stepwise manner. A screw connection is suitable for a stepless adjustment. For this, the filter disks can be equipped, for example, with a metallic rim on which is a screw thread that corresponds with an inner thread of the housing bore for the filter disk.

The seat of the filter disks may also be changed with spacer disks. Spacer disks are commercially available in many forms and in many thicknesses.

Depending on the feedstock to be processed, the offset of the filter disks can be slight or be some millimeters. Insofar as the offset is greater than the thickness of the housing shell, the filter disks can also be easily fitted externally on the housing shell. For this, it can be sufficient to clamp the filter disks on the housing shell.

The material layer deposited on the filter disk contributes to the filtering.

It was found that the flush or recessed filter disks may form both a flat surface as well as a different curvature than the curvature of the inner wall of the housing.

The angled forms of the filter disks are easily inserted into the suction opening of the housing, because the position of the filter disks is defined by the corners of the recess in the housing. However, other shaped filter disks can also be securely inserted into an opening of the housing shell.

Moreover, the small sinter disks permit an appreciable temperature control of the sinter disks through the surrounding supply housing or by means of a separate temperature control. Temperature control of the housing is usual for extruders. The influence of the extruder housing temperature control on a supply housing and a large filter built into the supply housing is, however, negligible. This is not the case for small filter disks, for which the influence of the housing temperature control is very much greater. A very thin and small disk can be much better heated or cooled.

The filter disks may optionally be made of non-metallic particles, such as ceramic particles. Such particles may also be pressed together. However, they may also be adhesively bonded together.

According to one possible exemplification, the thickness of the filter disks is in the range of 0.5 to 4 mm, or in the range of 1 to 3 mm. However, thicknesses greater than 4 mm may also occur. According to one possible exemplification, thicknesses are also included that are greater than the diameter of the filter disks.

The diameter of circular filter disks is in the range of 10 to 50 mm, or in the range of 20 to 40 mm. Filter disks with other shapes, for example rectangular or oval filter disks, may have the same filter surface area as the circular filter discs. However, the present application also encompasses the described deviations in the surface area. The listed tolerances also encompass a division into differently-shaped surfaces. The filter surface in this regard is the surface (flow surface area) against which the carrier gas flows during degassing. Insofar as the filter disk is enclosed in a housing or rim, only the surface that is surrounded by the border is counted as the flow surface area.

Sinter disks usually comprise steel particles or other metallic particles, which are bonded together by sintering to a porous mass. Sintering usually occurs by heating under pressure. Both heat and pressure can be varied within wide limits for the present application case. In the application according to the present application of small filter disks, the metallic particles have the additional advantage of a high thermal conductivity. The high thermal conductivity facilitates the temperature control.

As mentioned above, the sinter disks may also comprise non-metallic particles.

The porosity can be adjusted by the choice of the particles to be bonded together. The larger the particle, the larger are the interstices between the particles in the bulk material per se and also after the particles have been sintered. Spherical particles can be used as the starting material for the sinter disk. However, the particle shape depends greatly on the manufacturing process of the particles, their composition and their treatment. With ground particles it can be assumed that they have a more or less round shape. Whether they have for example an oval shape or are exactly spherical is not relevant in practice. In practice, other process-dependent regular and irregular particle shapes can mostly be disregarded in favor of the assumption of a spherical shape of the metallic particles.

In this regard, the required porosity is given by the size of the solid particles to be filtered out of the gas stream. Further determining factors for the porosity are the particle size distribution in the solid particles to be filtered off, the differential between the flow pressure of the carrier gas and the pressure of the carrier gas at the outlet side of the filter disks, the thickness of the layer of solid particles which is built up on the filter disks, and the operating period of the filter disks between two regeneration processes.

The maximum pore size of the filter disk may be smaller than the maximum size of the particles in the gas stream to be filtered. In this regard, it is assumed that initially a quantity of smaller particles will indeed pass through the filter. However, a layer of filtered-off particles is formed in front of the filter quite quickly. The small particles will also be filtered off out of the gas stream by this layer.

In another exemplification, the maximum pore size of the filter disk is smaller than the mean size of the particles to be filtered out of the gas stream.

Insofar as the particles to be filtered off are large enough, then the maximum pore size can also be smaller than the smallest particle size.

According to one possible exemplification, the mean particle size is determined from three one-liter gas volumes removed from the particle-containing gas stream. The gas volumes are taken at 15 minute intervals and left standing for 10 hours, in order to release the deposited particles into a stream of water and to classify the particles by sieves. The maximum particle size and the smallest particle size can be measured in the same manner.

Most finely-grained feedstocks have a mean diameter of 0.001 to 0.5 mm, or 0.03 to 0.4 mm.

Filter disks are preferably provided with a pore size that is larger the further the distance of the disk is from the inlet flow surface. According to one possible exemplification, this is achieved by means of the increasing size of the particles to be bonded together to form filter disks.

According to one possible exemplification, the filter disks comprise layers of different porosity, wherein the layers are arranged, such that the pore size increases from layer to layer, starting from the layer that forms the inlet flow surface (filter surface for the carrier gas loaded with particles). The thickness of the individual layers is at maximum 3 mm, or at maximum 2 mm, or at maximum 1 mm.

The layer-wise construction of the filter disks can be produced, for example, by separately manufacturing the different layers and then connecting them together. The connection may be mechanical, for example by a rim that encloses all the layers, or for example by adhesion. The layer-wise construction may also be made by initially placing the particles for the different layers into a mold and then sintering them together.

The increasing porosity of the filter layers can counteract clogging of the filter. This lengthens the cleaning cycles for the filter. The service life of the filter can optionally be increased up to the batch change-over in the extruder. The filter cleaning can then be made at the same time as the batch change-over, such that the operation of the extruder is not interrupted by the filter cleaning procedure. The filter cleaning is also referred to as the regeneration of the filter.

The division of the filter surfaces according to one possible exemplification offers additional advantages for unavoidable regeneration. If the operation of the extruder has to continue without interrupting the filtration, then this can be accomplished with an additional filter surface that is interchanged with the other filter surface, wherein the filter surfaces that are not being used for degassing are regenerated. Pressurized gas may be used for the regeneration. The regeneration is optionally carried out with the carrier gas that was suctioned off from a previously-used working filter surface. A number of other gases may also be utilized, such as air. With adequate pressurization of the gas provided for the regeneration, one or a few pressure surges suffice in order to blow free the filter disks in question. This type of gas is commercially available as compressed air, available for example in compressed air cylinders. Other gases, also inert gases, are also similarly available. For higher consumptions of compressed air it is possible to use a compressor from which lines lead to the suction lines that are provided on each filter surface for suctioning off the gas. The same lines can be provided when compressed air cylinders are used. The nearer the compressed air lines on the filter surfaces discharge into the suction lines, and the closer a valve for sealing the suction line is arranged to the mouth of the compressed air line, the lower the gas volume required for the regeneration. Combined gate valves may be provided which, when actuated, initially close the suction line and then open the compressed air line to admit flow onto the filter disks. The valve, shortly after opening, is moved back again into the starting position. This creates a pressure surge. The procedure can be repeated as often as needed.

During the regeneration the generated pressure surges cause very little gas/air to penetrate from the filters into the inlet to the extruder. There, it is blended with the gas to be suctioned off. The regeneration of the filter preferably occurs before the filter disks have become clogged up. More often the regeneration is preferably already initiated when the mean flow resistance through the filter disks has noticeably increased. The mean flow resistance may be determined from the progression of the value of the flow resistance over a period of at least 20 seconds, or over a period of at least 40 seconds, or over at least 60 seconds. On the way the effect of changes of the flow resistance is attenuated, such that possibly only significant changes of a certain time may trigger the regeneration.

Furthermore, regeneration is preferably carried out firstly as of a change in the mean flow resistance of at least 10%, more preferably as of at least 20% and most preferably as of at least 30%. The percent figures refer to the mean flow resistance for the start-up of the filter disk and assume the same pressure on the inlet flow side of the filter disk as for the start-up and the same reduced pressure on the opposite side of the filter disk as for the start-up. Optionally, the rotational speed of a propeller located in the suction line, and which turns freely in the flow of the extracted gas, is exploited to determine the level of the flow resistance. In this regard the propeller may be integrated in the suction line, such that the suction line forms its housing. The propeller may also possess its own housing, such that the suction line is flange-mounted on the housing.

In order not to have to modify the operation of the measurement unit, one can empirically determine the rotational speed values which result from the different pressures at the inflow side and outflow side on a filter disk to be regenerated. Then each inlet side/outlet side pressure situation can be assigned to a certain rotational speed of the rotating propeller; the regeneration of the filter disk will be initiated if the speed falls below this value. A modification of the operating situation is then not required in order to determine the need for regeneration. Besides the rotational speed of the propeller, solely the gas pressure in the supply line and the pressure in the line for the extracted gas have to be measured.

The lower the quantity of gas used for a pressure surge, the less influence the pressure surges have on the material feed to the extruder. Moreover, the volume of the supply has an influence on the pressure situation. The greater the volume of the particle supply, the lower the effect of pressure surges on the filter regeneration.

The pressure surges not only blow free the filter, but also remove each layer of particles built up on the filters. The layer builds up as the particles are filtered out of the extracted gas in front of the filter disks.

The layer thickness can be limited by a stuffing screw. The stuffing screw can be designed as a type of single screw extruder. Instead of a stuffing screw, two screws in the form of a twin screw may be provided as a type of a twin screw extruder. Hereinafter, mention will only be made of a stuffing screw. This includes the twin screw.

The stuffing screw is rotated in the supply line to the extruder provided for processing the plastic. The supply line then forms at the point the housing of the stuffing screw and surrounds the stuffing screw with at least the necessary clearance. The stuffing screw may also be located in its own housing. The housing then stands above the inlet opening of the extruder provided for processing the plastic. The supply line may be flange mounted above or laterally on the housing. In the case where a single screw is used as the stuffing screw, the housing has the form of a funnel. In the case where a twin screw is used as the stuffing screw, a funnel-shaped outlet opening is provided on the housing of the stuffing screw.

However, an additional clearance between the stuffing screw and the surrounding feed line/housing may also be provided. This clearance and the clearance of the filter disk from the stuffing screw determine the possible layer thickness of the particles on the inlet flow surface of the filter disks. In this regard the filter disks may close/be flush with the inner surface of the supply line/housing. However, the filter disks may also be set back from the inner surface of the supply/housing or close flush with the inner wall of the housing or even protrude from the inner wall of the housing.

The stuffing screw removes all or essentially all or substantially all particles in its reach from the filter disks. The stuffing screw pushes the particles removed from the filter disks into the inlet opening of the extruder.

Depending on the nature of the particles, it may be of advantage to temper the filter disks. For this, the filter disks according to one possible exemplification may be held in a temperature controllable frame. This may be a common frame for a plurality or all filter disks, or a separate frame is provided for each filter disk. All the separate frames can also be combined to form an overall construction. The frames possess channels for the passage of temperature-control agents. The frames also optionally possess a connection to the channels for temperature-control agents in the particle supply/supply housing of the stuffing screw.

The phrase “temperature control” means that in order to maintain a desired temperature, heat is supplied to the filter disks, or heat is removed from the filter disks. The temperature control of the supply/housing may be carried out in the same way as the temperature control of the extruder. A simplified temperature control is also optionally provided on the particle supply/supply housing.

The temperature control of the extruder may be achieved with water. Oil is sometimes used for the temperature control of the extruder. Water is also used as a temperature control agent for the particle supply/supply housing. However, air-cooling may also be considered. The air-cooling may then be supported with a fan.

An extruder is often temperature controlled with a double-shell extruder housing. A temperature control agent flows through both shells. The temperature control agent is usually water. However, oil may also be used as the temperature control agent.

The temperature control occurs by controlled heat exchange. As needed, the temperature control agent supplies heat or removes heat from the extruder. As needed, the temperature control agent is utilized for heating or for cooling. The temperature control agent that has cooled down after heating the extruder is brought back again in a heat exchanger to the required temperature for heating. The temperature control agent that has warmed up after cooling the extruder is brought back again in a heat exchanger to the required temperature for cooling.

When the temperature control unit of the extruder is used to control the temperature of the particle supply/supply housing then a connection may be provided between the heat exchanger of the extruder heat exchanger unit and the particle supply/supply housing, such that as the extruder is heated the particle supply/supply housing can be heated at the same time, and as the extruder is cooled the particle supply/supply housing can be cooled at the same time.

On the double shell extruder housing the temperature control agent is guided between both shells with stays. The stays are preferably a component of the inner or of the outer shell of the extruder housing. The stays are usually created by incorporating guide grooves in the surface of the chosen shell. Channels are formed from the guide grooves in one shell if the guide grooves of the other shell are closed by bringing together both shells.

The guide grooves can be designed to run like screw threads with a chosen lead. The guide grooves may be single threaded or multiple threaded. With double threaded grooves there are two threads beside one another. This means that with these grooves the threads wind together like a screw thread in the surface of the shell of the extruder housing. With double threaded grooves two times as much temperature control agent can be transported as with a single threaded groove of the same groove cross section and otherwise identical conditions. With triple threaded grooves the quantity is tripled, etc.

The temperature control agent is fed in, for example, at one housing end into the guide grooves and removed at the other end of the housing. A plurality of points for supplying and removing the temperature control agent may also be provided on a housing, such that on a housing a plurality of points are present that can be temperature controlled independently of each other.

If there are connections for a supply of material into the extruder, then a possible arrangement of the channels for the temperature control agent in the double shell jacket of the particle supply/supply housing is when the channels for the temperature control agent do not end at the connections, but rather are guided around the connections.

The channels positively guide the temperature control agent. Optionally, the temperature control agent may also flow without positive guidance (without channel formation) through the cavity of the double shell jacket of the particle supply/supply housing. This construction design reduces the manufacturing costs.

Stuffing screws/stuffing devices can be used in combination with extruders, even in combination with planetary roller extruders. The stuffing screw/stuffing device may also be utilized if the feedstock provided for the extruder does not feed solely by gravity from the feed hopper of the feed section into the inlet opening. This is the case for fibers, for example, which are to be blended with plastic. The stuffing screw/stuffing device then forces the feedstock into the inlet opening of the extruder.

The air/gas and the particulate feedstock to be fed into the extruder can be separated before the material enters into the feed zone of the extruder. The feed zone is the section of the extruder in which the major components of the feedstock are supplied to the extruder. Additional material may also be fed at other points of the extruder.

Single screw extruder modules can be employed in the feed zone. However, twin screw extruder modules and even planetary roller extruder modules may also form the feed zone.

Only one screw is provided in a single screw module. The single screw has the advantages of low costs and a high pressure build-up in the feedstock. Usually, for subsequent extrusion zones, additional single screw modules are connected to the single screw module of the feed zone. However, other modules, such as planetary roller extruder modules, may be connected. Planetary roller extruder modules possess an inner toothed housing, a central spindle that rotates in the housing, and planetary spindles that rotate between the central spindle and the housing. This central spindle and the planetary spindles are toothed on their periphery. The central spindle intermeshes with the planetary spindles and the latter intermesh with the inner toothed housing.

In the twin screw extruder module for the feed zone, two intermeshing, parallel arranged screws cooperate. In practice only additional twin screw extruder modules are connected to the twin screw extruder module.

A planetary roller extruder module provided as the feed zone possesses the same elements as have been previously described. However, particular planetary spindles may be provided for this, and different designs of planetary spindles can be used.

In normal planetary spindles the toothing runs uniformly from one end of the spindle to the other end of the spindle.

“Igel” spindles result when circular recesses/grooves are worked into the normal toothing at regular distances. In this regard, the edges of the grooves/walls may not be perpendicular to the longitudinal axis of the spindle, but rather run at an angle to it.

“Noppen” spindles result when a counter rotating toothing is incorporated into a normally toothed spindle.

“Transport” spindles result when one or more teeth are removed over a significant length on a normally toothed spindle.

Combined spindles result when the spindles exhibit different toothings on a single spindle.

For all types of spindles it may be helpful when the teeth exhibit a flattening in the region with which they move past the filling opening. This enlarges the space in the feed section.

The flattening also may occur in a zone that is associated in the direction of rotation with the inlet opening. With a sufficient stability of the planetary spindles the partial lack of support for the planetary spindles by the flattening has no or essentially no effect on the planetary spindles. The planetary spindles are adequately held at their ends between the central spindle and the inner toothing of the housing because the inner toothing of the housing possesses a full set of teeth there. The additional bending load of the planetary spindles resulting from the lack of support is readily borne by typical planetary spindles.

In principle, the flattening in the direction of rotation of the central spindle can run uniformly. However, there may be less flattening in the direction of rotation of the central spindle. This results in a funnel-shaped enlargement of the cavity between the inner toothing of the housing and the central spindle. This enlargement reduces the resistance of the feedstock as it enters the extruder. The funnel-shape steers the feedstock in an advantageous manner between the planetary roller parts of the feed section.

The flattening may be made as far as the tooth root. The height of the tooth may be reduced by 90% at most, or by 80% at most.

In spite of the flattening, all of the feedstock that reaches the space of the previous tooth gaps is always still thrust through the teeth of the rotating planetary spindles. In order to also prevent deposits from occurring on the flattenings, the flattened teeth may be equipped with new, less inclined tooth flanks, such that new teeth with a preferably rounded tooth head are created there, and the feedstock displaced from the previous tooth root pushes aside all the feedstock that sticks to the new tooth flanks.

Such modifications to the teeth can be produced, among other things, with electrically driven erosion devices. An electrode is used for this which matches the desired new shape of the flattened tooth and is dipped with the housing into an erosion bath. The electrode is moved closely above the toothing to be flattened and a current is applied to the work piece, such that molecules are released from the surface of the toothing to be flattened and migrate to the electrode.

As the toothing to be flattened becomes increasingly shaped, the electrode is adjusted, such that a desired, small clearance is maintained.

The described space enlargement by flattening the inner toothing of the housing is dependent on how far the flattening extends in the direction of rotation of the central spindle and how far the flattening extends in the axial direction of the central spindle.

The extent of the flattening may be at least one-tenth, or at least one-fifth, or at least one-half of the circumference of the pitch circle diameter of the inner toothing of the housing.

The extent of the flattening in the axial direction of the central spindle is called the width. The width is up to 30% larger or smaller than the opening width of the inlet opening, or up to 20% larger or smaller than the opening width of the inlet opening, or up to 10% larger or smaller than the opening width of the inlet opening. The width of the flattening may also be equal to the opening width of the inlet opening.

In practice, for some transport spindles, at least three teeth that are uniformly distributed about the spindle periphery are removed. Optionally, more teeth are also removed. At least three may remain evenly on the periphery of each of the planetary spindles. Each fourth or each third or each second tooth may also be removed. Also, all teeth except one may be removed. Insofar as more than one tooth remains, the teeth may be uniformly distributed about the periphery of the spindles.

This removal of teeth results in a reduced number of teeth in contrast to a non-reduced number of teeth. The teeth may be removed down to the tooth root. It is also conceivable to remove more material or to remove only parts of the teeth. Alternatively, the transport spindles are manufactured at the outset in a shape that results if a single tooth or a plurality of teeth were removed from a standard spindle.

By removing certain teeth completely or partially, and the other teeth remain, there results a planetary spindle with more conveying effect.

It has been found that the transport spindles, in contrast to other planetary spindles, readily take up the material that runs from a feed hopper into the planetary roller extruder section/module.

The number of teeth remaining on the transport spindles is optionally up to 4, preferably 3, even more preferably 2 and most preferably 1.

The “complete or partial” design according to one possible exemplification of the planetary spindles as transport spindles means that: (a) planetary spindles outside the zone of the inlet opening are equipped with a different toothing; and/or (b) transport spindles in the zone of the inlet opening are combined with planetary spindles with a different toothing.

It is advantageous when the planetary spindles, outside the inlet zone, possess a normal toothing on the end facing towards the conveying direction. There, the greater conveying effect of the normal toothing is exploited in order to prevent the incoming feedstock from spreading out against the conveying direction of the extruder. However, a normal toothing may also be provided outside the inlet zone on the conveying direction of the planetary roller extruder section/module.

Planetary spindles of a planetary roller extruder section/module serving as a feed part which are optionally designed as transport spindles may be combined with differently designed planetary spindles. This means that the array of planetary spindles (the total of all planetary spindles) of a planetary roller extruder section/module serving as a feed part may optionally also partly comprise differently toothed planetary spindles. The proportion of the planetary spindles with transport spindle toothing may be at least 50%, or may be at least 70%, or may be at least 90% of the array of planetary spindles.

When transport spindles are partly used in the array of planetary spindles, then the planetary spindles with transport spindle toothing may be uniformly distributed in the array of the planetary spindles.

In an array of planetary spindles that is wholly equipped with transport spindles, the number of teeth on the transport spindles is chosen in such a manner that, within at least 10 rotations of the planetary spindles about the central spindle, one planetary spindle tooth engages in each tooth gap of the central spindle toothing and one tooth engages in each tooth gap of the inner toothing of the surrounding housing. This tooth engagement may occur within at least seven rotations of the planetary spindles about the central spindle, or within at least four rotations of the planetary spindles about the central spindle, or within one rotation of the planetary spindles about the central spindle. The tooth engagement cleans the toothing.

The tooth engagement can be checked/displayed, for example, in that a colored, room temperature liquid material with sufficient adhesion to planetary spindles, the central spindle and inner toothing of the housing, is smeared in their tooth gaps. It can then be clarified how many rotations of the planetary spindles about the central spindle are required for a desired tooth engagement. This is done by opening the feed part according to one possible exemplification, for example after one rotation or after four rotations or after seven rotations or after 10 rotations of the planetary spindles about the central spindle.

In the process the rotation of the planetary spindles about the central spindle is in a fixed relation to the rotation of the central spindle. For the above check/display, the central spindle of the feed part can be easily turned by hand if the feed part has been released from the other extruder sections/modules. In this regard the movement of the central spindle can be simulated with a sample piece of the central spindle. If the desired tooth engagement is not obtained within the desired number of rotations of the planetary spindles about the central spindle, then the planetary spindles can be replaced by other planetary spindles or additional planetary spindles may be used. The other planetary spindles may possess as transport spindles more teeth and/or differently arranged teeth. Optionally, it already suffices to replace one transport spindle by a normally toothed planetary spindle in order to ensure that in each rotation of the planets there occurs one engagement in each tooth gap on the central spindle and on the inner toothed housing.

In contrast to the feed part according to one possible exemplification, a conventional feed screw does not have comparable cleaning action in a feed part. The screw is dependent on the fact that incoming feedstock pushes out the preceding material. This can hardly be checked. The feedstock flows wherever the lowest resistance opposes it. It cannot be guaranteed that the same resistances occur everywhere in the whole of the flow space in the feed part left open by the screw. The slightest scorch/sticking may already exert a lasting negative influence on the flow behavior. Hardly any cleaning occurs in the absence of intervention by the operational personnel.

In contrast, in a planetary roller extruder, each tooth engagement necessarily leads to cleaning. This can be designated as self-cleaning.

Depending on the extrusion material, degassing may be required.

The above-discussed exemplifications of the present invention will be described further herein below. When the word “invention” or “exemplification of the invention” is used in this specification, the word “invention” or “exemplification of the invention” includes “inventions” or “exemplifications of the invention”, that is the plural of “invention” or “exemplification of the invention”. By stating “invention” or “exemplification of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

FIG. 1 shows an extruder unit is illustrated schematically;

FIG. 2 shows details of the feed device;

FIG. 3 shows a plurality of filter modules arranged vertically one above the other;

FIG. 4 shows an exemplification of a twin screw;

FIG. 5 shows another exemplification of a twin screw;

FIG. 6 shows a test device with a twin screw as the stuffing screw; and

FIG. 7 shows a section of the device shown in FIG. 6.

### DESCRIPTION OF EXEMPLIFICATION OR EXEMPLIFICATIONS

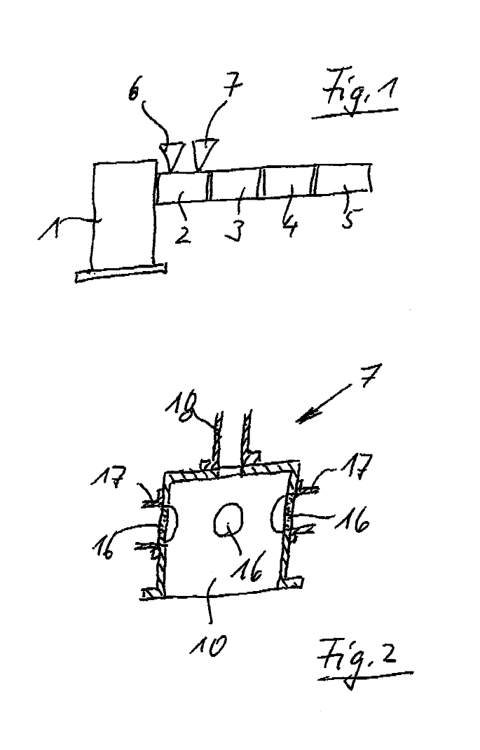

In FIG. 1 an extruder unit is illustrated schematically. A drive is designated 1, with a feed part 2 and with other extruder parts 3, 4, 5. The feed part 2 is designed as a single screw module. The extruder parts 3, 4, 5 are designed as planetary roller extruder modules. On the feed part 2 are schematically illustrated two material feed devices 6 and 7, which feed into inlet openings of the feed part 2. In the exemplification shown, plastic and additives are fed by the material feed device 6 into the extruder. In the exemplification shown, dusty components of the mixture—ground colorant particles—are fed into the extruder by the feed device 7.

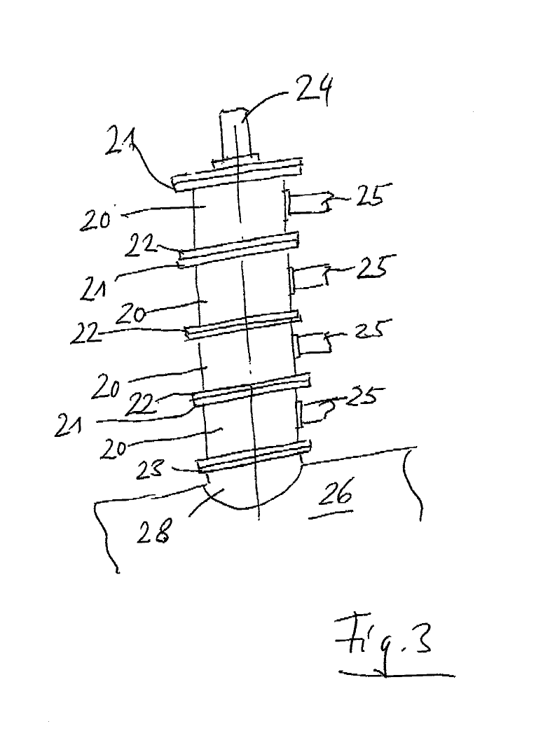

FIG. 2 shows details of the feed device 7. It possesses a supply housing 10, which can be cylindrical in shape or another shape, that is seated directly above an inlet opening in the housing of the extruder. Four filter disks 16 made of sinter metal are inset in the supply housing 10 of the exemplification. Suction lines 17, through which gas that has penetrated into the supply housing 10 is suctioned off, are provided on the filter disks 16. This occurs through a supply line 18. The ground colorant particles are entrained with the gas into the supply housing 10.

As the gas is suctioned off through the filter disks 16 the colorant particles are deposited onto the filter disks. Thus, in front of the filter disks 16 there forms a particle layer which falls off when the layer reaches a certain thickness. The particles fall into the inlet opening of the extruder.

In other words, according to one possible exemplification, materials that can be conducted by air or gas are fed into the supply housing 10 via the supply line 18. These materials can be, for example, lightweight and/or granular materials in the form of dust particles or particles that are dust-like or powders or of similar size capable of being conducted by or entrained in a flow of air or gas. After the materials exit the supply line 18, they are drawn by suction toward a plurality of suction lines 17 that open into the housing 10. The opening or entrance into each suction line 17 is covered by a corresponding filter or filter cover 16. The filters 16 are designed to filter the materials out of the air and at least temporarily retain the materials on the filters 16. As more and more material is fed into the supply housing 10, more and more material builds up on the filters 16. When the amount of material on a filter 16 reaches a certain amount or level or weight, air flow through the filter 16 is reduced and the material falls off of the filter 16 by gravity. The material is then fed into the extruder for further processing. In this manner, only or essentially only or substantially only the material is fed into the extruder, thereby reducing or restricting or minimizing the amount of gas in the material processing sections of the extruder, which thereby obviates the need for degassing structures that complicate the design of the extruder.

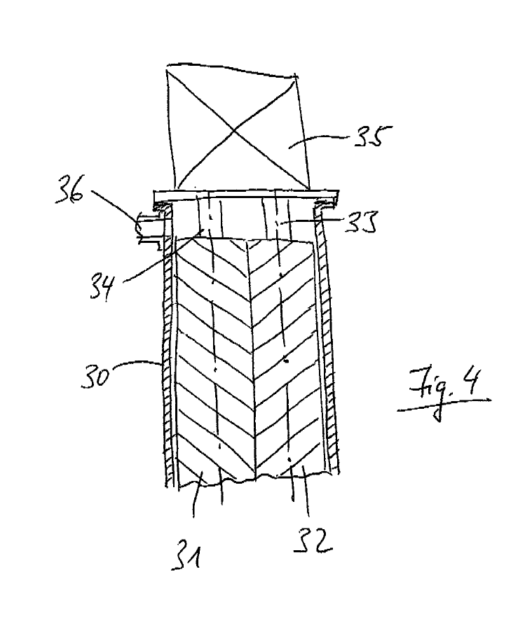

In FIG. 3, a plurality of filter modules are arranged vertically one above the other. All modules possess a housing 20. Flanges 21 and 22 are provided on each end of the housings 20. The housings are clamped together at the flanges 21 and 22.

The housing modules that are clamped together form a pipe-shaped filter chamber with a plurality of suction openings and suction lines 25 connected thereto. The modules that are connected together to form a tubular filter chamber sit vertically on a flange 23 of an inlet nozzle 28 on the extruder housing 26. There is an intake 24 or supply line for the supply of particles to be filtered out of an air flow.

In other exemplifications, a stuffing screw is provided in the supply housing 10. The stuffing screw is in an overhung position in the housing cover. Above the cover, in the center of the cover, is fixed a drive that also forms the bearing for the stuffing screw. The supply line for the gas and the particles is then provided laterally from the center in the cover.

The stuffing screw fills out the inner chamber of the supply housing 10 apart from a necessary clearance. Each rotation of the screw scrapes off the particles deposited on the filter disks and forcibly conveys the particles downwards into the inlet opening/feed opening of the extruder. There, the particles from the feed screw in the feed part 2 are pulled into the extruder. The particles are blended with the other feedstock in further sections of the extruder.

In still other exemplifications two intermeshing stuffing screws are arranged as a type of twin screw extruder in the supply housing.

In the exemplification the stuffing screw is a twin screw extruder for a size 70 planetary roller extruder. In this regard the supply housing is the housing of the twin screw extruder. This means that the filter disks are arranged in the housing of the twin screw extruder that forms the stuffing screw.

The twin screw extruder that forms the stuffing screw stands vertically on the housing of the planetary roller extruder.

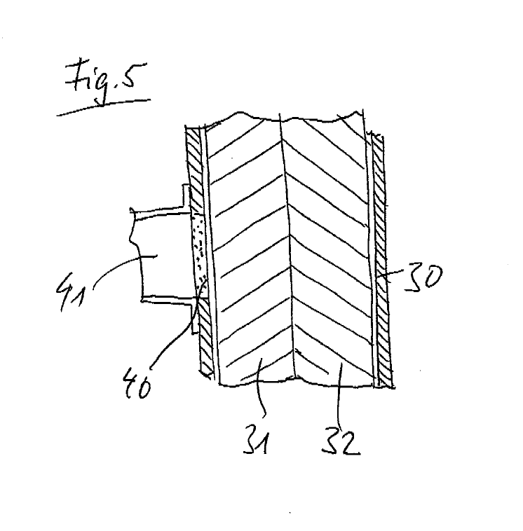

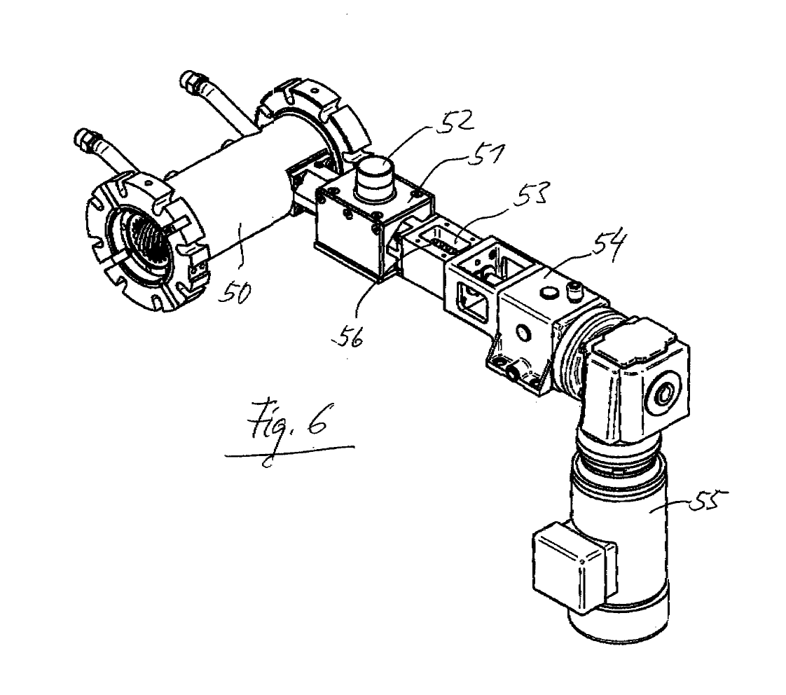

FIGS. 4 and 5 show a type of twin screw that includes two intermeshing screws 31 and 32. The housing 30 stands vertically on the inlet opening of the extruder. The outlet end of the housing 30 stands on the inlet opening of the extruder. A drive with a gear 35 is located on the upper end of the housing. The gear 35 is in drive connection with both the screws 31 and 32 and also forms a bearing for the screw ends 33 and 34. A supply line 36 for the particle-containing air is located on the side of the housing 30.

Various suction openings can be provided on the housing 30. As shown in FIG. 5, each suction opening has a suction line 41 attached with which the air is extracted from the housing 30. The particles entrained in the air are retained in the housing 30 by the filter disks 40 that are seated in the suction openings. In this regard, a layer of particles is formed in front of the filter disks 40. As soon as the layer of particles accumulates, such that particles reach the effective range of the rotating screws 31 and 32, the particles are carried away by the screws 31, 32. Consequently, the layer of particles in front of the filter disks has an essentially constant thickness. The layer of particles thus contributes to the filter process.

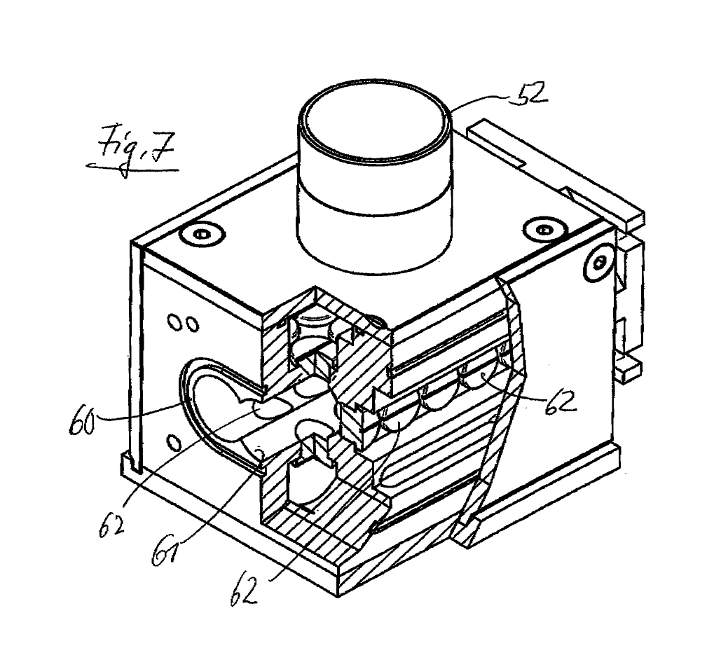

FIGS. 6 and 7 show a test device with an above-described twin screw as the stuffing screw. FIG. 6 shows the extruder 50 to which the particles are intended to be supplied. A filter 51 with air suction 52 is mounted laterally by flanges on the extruder 50. A housing 53 for supplying air loaded with particles is provided laterally on the filter 51. The supply line for the particle-loaded air is flange mounted (not shown) on a cover plate of the supply 53.

Two intermeshing screws 56 that form the twin screw pass through the housing 53 and the filter. The screws 56 are driven by a gear 54 connected to a motor 55.

The screws 56 run in the surrounding bearing walls 60 and 61. Filter disks 62 are set into these walls 60 and 61. Between these walls 60 and 61 and the surrounding housing walls there is a cavity or space in which a reduced pressure is created by the air suction.

Although the screws 56 run horizontally the screws 56 carry the filtered-off particles into the extruder 50.

For testing, the equipment was operated with powder coating and powdered rubber. With this equipment in the application with powder coating, an output of 18 kg per hour was achieved without an induced draft and an output of 25 kg per hour with an induced draft. In the application with powdered rubber, with this equipment an output of 35 kg per hour was achieved without an induced draft and an output of 46 kg per hour with an induced draft.

The increased output is due to the suctioned-off air.

When a different carrier gas was used instead of air the same increase in output was obtained.

Suctioning-off the air or a different carrier gas in the above described manner also quite significantly reduces the ingress of the carrier gas into the extruder.

In other exemplifications other stuffing screws are provided.

In still other exemplifications the filtration is carried out without stuffing screws.

The supply housing stands vertically or is at least strongly or substantially inclined, such that the particles filtered out of the carrier gas drop or roll under their own weight into the inlet opening of the extruder.

Some examples of planetary roller extruders that are used for the continuous processing of plastics and their method of operation and components thereof that may possibly be utilized or adapted for use in at least one possible exemplification may possibly be found in the following: DE19939075 A1, CA698518, DE19653790 A, DE19638094 A1, DE19548136 A1, DE1954214 A, DE3908415 A, DE19939077 A, EP1078968A1, EP1067352 A, EP854178 A1, JP3017176, JP11080690, JP9326731, JP11-216754, JP11-216764, JP10-235713, WO2007/0874465 A2, WO2004/101627 A1, WO2004/101626 A1, WO2004/037941 A2, EP1056584, PCT/EP99//00968, WO94/11175, U.S. Pat. No. 6,780,271 B1, U.S. Pat. No. 7,476,416.

Some examples of planetary roller extruders and their sections or modules and their method of operation and components thereof that may possibly be utilized or adapted for use in at least one possible exemplification may possibly be found in the following: DE102005007952 A1, DE102004061068 A1, DE102004038875 A1, DE102004048794 A1, DE102004048773 A1, DE102004048440 A1, DE102004046228 A1, DE102004044086 A1, DE102004044085 A1, DE102004038774 A1, DE102004034039 A1, DE102004032694 A1, DE102004026799 B4, DE102004023085 A1, DE102004004230 A1, DE102004002159 A1, DE19962886 A1, DE19962883 A1, DE19962859 A1, DE19960494 A1, DE19958398 A1, DE19956803 A1, DE19956802 A1, DE19953796 A1, DE19953793 A1.

Some examples of ways to separate air from extruder feedstock that may possibly be utilized or adapted for use in at least one possible exemplification may possibly be found in the following: U.S. Pat. No. 5,772,319 and DE2251425.

Some examples of methods and devices and components thereof for degassing extruders that may possibly be utilized or adapted for use in at least one possible exemplification may possibly be found in the following: DE112009001885, DE112007002171, DE112005002824, DE102013204312, DE102013108369, DE102013101997, DE102013007132, DE102013006667, DE102013000596, DE102013319966, DE102012217383, DE102012217383, DE102012212675, DE102012208778, DE102012202005, DE102012107430, DE102012100710, DE102012022346, DE102012020011, DE102012019908, DE102012008169, DE102012005450, DE102011102923, DE102011088959, DE102011083988, DE102011082441, DE102011076993, DE102011076257, DE102011050314, DE102011011202, DE102011011202, DE102011007425.

An example of a method and device for feeding plastic processing devices with feedstock that may possibly be utilized or adapted for use in at least one possible exemplification may possibly be found in the following: CH505679.

Some examples of the design of a twin screw extruder with a gas-permeable wall made of sintered material that may possibly be utilized or adapted for use in at least one possible exemplification may possibly be found in the following: EP1977877 and EP2218568.

Some examples of filters for filtering air or gas with feedstock material entrained therein or conducted or moved thereby that may possibly be utilized or adapted for use in at least one possible exemplification may possibly be found in the following: DE3310676.

An example of a temperature control extruder and components thereof that may possibly be utilized or adapted for use in at least one possible exemplification may possibly be found in the following: DE102006018686.

Some examples of stuffing screws or stuffing devices for feeding feedstock that may possibly be utilized or adapted for use in at least one possible exemplification may possibly be found in the following: DE102007050466, DE102007041486, DE20003297, DE19930970, DE102008058048, DE102007059299, DE102007049505, DE102006054204, DE102006033089, DE102004026599, DE19726415, DE10334363, DE20200601644, DE20200401971, DE10201000253, DE102009060881, DE102009060851, DE102009060813.

Some examples of transport spindles and related components and devices that may possibly be utilized or adapted for use in at least one possible exemplification may possibly be found in the following: DE102006033089 A1, EP1844917 A2, DE2702390 A, EP1833101 A1, DE10142890 A1, U.S. Pat. No. 4,981,711, GB2175513 A, U.S. Pat. No. 5,947,593, DE2719095.

Some examples of degassing procedures and devices for performing degassing and components thereof that may possibly be utilized or adapted for use in at least one possible exemplification may possibly be found in the following: DE102004061185A1, DE102004060966A1, DE102004053929A1, DE1020040050058A1, DE102004004237A1, DE69908565T2, DE69827497T2, DE69807708T2, DE69725985T2, DE69715781T2, DE69715082T2, DE69711597T2, DE69710878T2, DE69709015T2, DE69707763T2, DE69630762T2, DE69628188T2, DE69622375T2, DE69428309T2, DE69427539T2, DE69419146T2, DE69312852T2, DE69312246T2, DE69306874T2, DE69207369T2, DE68928567T2, DE68915788T3, DE60206271T2, DE60012108T2, DE19956483A1, DE19954313A1, DE10257377A1, DE10356821A1, DE10354546A1, DE10354379A1, DE10352444A1, DE10352440A1, DE10352439A1, DE10352432A1, DE10352431A1, DE10352430A1, DE10351463A1, DE10349144A1, DE10345043A1, DE10343964A1, DE10342822A1, DE10340977B4, DE10340976B4, DE10333927A1.

One feature or aspect of an exemplification is believed at the time of the filing of this patent application to possibly reside broadly in an extruder for processing feedstock wherein the extruder possesses a housing in which, when designed as a single screw extruder is seated only one screw, or in which, when designed as a planetary roller extruder an externally toothed central spindle and various externally toothed planetary spindles rotate, which mesh simultaneously with the toothing of the central spindle and with an inner toothing of the extruder housing, or wherein the extruder consists of a combination of a section, designed as a type of single screw extruder, with a downstream section that is designed as a type of planetary roller extruder, wherein the section designed as a type of single screw extruder receives the feedstock, and the downstream section that is designed as a type of planetary roller extruder is at least involved in the further processing of the feedstock, or wherein the feedstock is received in a section designed as a type of planetary roller extruder, wherein prior to entering into the extruder, the feedstock is subjected to an at least partial separation of the solids from the carrier gas, wherein a filter that is seated in the line or in a supply housing is used for the separation, wherein more than 50%, preferably more than 70%, even more preferably more than 80% and most preferably more than 90% of the carrier gas, due to a pressure drop at the filter, escapes through the filter, wherein a filter is used that is composed of at least two porous filter disks that exhibit a mean diameter of 10 to 50 mm, preferably a mean diameter of 20 to 40 mm, wherein the various filter disks are preferably uniformly distributed on the periphery of the line or of the supply housing, wherein the filter disks consist of sinter material, and wherein the remaining carrier gas together with other gases that are released during the extrusion in the extruder, are stripped away.

Another feature or aspect of an exemplification is believed at the time of the filing of this patent application to possibly reside broadly in the extruder, wherein there is feedstock that consists at least partly of particles with a low weight, such as finely grained, granular, dusty particles and fibers or the like, which are entrained with air or a similar carrier gas through a line to the extruder,

Yet another feature or aspect of an exemplification is believed at the time of the filing of this patent application to possibly reside broadly in the extruder, wherein the extruder uses filters of metallic and/or non-metallic filter particles.

Still another feature or aspect of an exemplification is believed at the time of the filing of this patent application to possibly reside broadly in the extruder, wherein the extruder comprises modular-wise composed filter housing, such that the filter surface is modifiable by incorporating additional housing modules with additional filter housings or by removing housing modules.

Another feature or aspect of an exemplification is believed at the time of the filing of this patent application to possibly reside broadly in the extruder, wherein the extruder uses filter disks with a thickness of 0.5 to 4 mm, preferably 1 to 3 mm.

Yet another feature or aspect of an exemplification is believed at the time of the filing of this patent application to possibly reside broadly in the extruder, wherein the extruder uses filter disks, whose pore size on the inflow surface is smaller than the maximum size of the particles to be introduced into the extruder.

Still another feature or aspect of an exemplification is believed at the time of the filing of this patent application to possibly reside broadly in the extruder, wherein the extruder uses filter disks, whose pore size on the inflow surface is smaller than the mean size of the particles to be introduced into the extruder.

Yet another feature or aspect of an exemplification is believed at the time of the filing of this patent application to possibly reside broadly in the extruder, wherein the extruder uses filter disks, whose maximum pore size on the inflow surface is smaller than the smallest size of the particles to be introduced into the extruder.

A further feature or aspect of an exemplification is believed at the time of the filing of this patent application to possibly reside broadly in the extruder, wherein the extruder uses filter disks, whose pore size on the inflow surface is matched to a mean solid particle diameter of 0.001 to 0.5 mm, preferably 0.03 to 0.4 mm.

Another feature or aspect of an exemplification is believed at the time of the filing of this patent application to possibly reside broadly in the extruder, wherein the extruder uses filter disks, whose pore size increases with increased distance from the inflow surface.

Yet another feature or aspect of an exemplification is believed at the time of the filing of this patent application to possibly reside broadly in the extruder, wherein the extruder uses multi-layer filter disks.

Still another feature or aspect of an exemplification is believed at the time of the filing of this patent application to possibly reside broadly in the extruder, wherein the extruder uses filter disks made of different layers.

A further feature or aspect of an exemplification is believed at the time of the filing of this patent application to possibly reside broadly in the extruder, wherein the extruder uses filter disks which comprise separately manufactured layers.

Another feature or aspect of an exemplification is believed at the time of the filing of this patent application to possibly reside broadly in the extruder, wherein the extruder uses filter disks whose layers have been sintered together.

Yet another feature or aspect of an exemplification is believed at the time of the filing of this patent application to possibly reside broadly in the extruder, wherein the extruder uses round and/or angled filter disks.

Still another feature or aspect of an exemplification is believed at the time of the filing of this patent application to possibly reside broadly in the extruder, wherein the extruder uses circular or oval filter disks or square or rectangular or hexagonal filter disks.

A further feature or aspect of an exemplification is believed at the time of the filing of this patent application to possibly reside broadly in the extruder, wherein the filter disks have the same or a different curvature than the housing wall or are flat.

Another feature or aspect of an exemplification is believed at the time of the filing of this patent application to possibly reside broadly in the extruder, wherein the filter disks are adjustably held in the supply housing.

Yet another feature or aspect of an exemplification is believed at the time of the filing of this patent application to possibly reside broadly in the extruder, wherein the extruder uses filter disks that are flush with the inner surface of the supply housing or are set back from the inner wall of the supply housing.

Still another feature or aspect of an exemplification is believed at the time of the filing of this patent application to possibly reside broadly in the extruder, wherein the filter disks are held in a frame.

A further feature or aspect of an exemplification is believed at the time of the filing of this patent application to possibly reside broadly in the extruder, wherein the extruder uses a temperature control of the filter disks and/or by a temperature control of the supply housing and/or a temperature control of the line.

Another feature or aspect of an exemplification is believed at the time of the filing of this patent application to possibly reside broadly in the extruder, wherein the extruder uses a temperature control with water or oil or air, wherein a fan may also be provided for the temperature control with air.

Yet another feature or aspect of an exemplification is believed at the time of the filing of this patent application to possibly reside broadly in the extruder, wherein the extruder uses at least one stuffing screw in the line or in the supply housing.

Still another feature or aspect of an exemplification is believed at the time of the filing of this patent application to possibly reside broadly in the extruder, wherein the extruder uses two stuffing screws that intermesh like the screws of twin screw extruders.

A further feature or aspect of an exemplification is believed at the time of the filing of this patent application to possibly reside broadly in the extruder, wherein the stuffing screw or screw have a vertical or horizontal or inclined configuration.

Another feature or aspect of an exemplification is believed at the time of the filing of this patent application to possibly reside broadly in the extruder, wherein the extruder permits a layer of particles that builds up in front of the filter as a component of the filter.

Yet another feature or aspect of an exemplification is believed at the time of the filing of this patent application to possibly reside broadly in the extruder, wherein the stuffing screw, or the twin screw, is arranged at a distance from the filter which is equal to the desired thickness of the layer of particles in front of the filter.

Still another feature or aspect of an exemplification is believed at the time of the filing of this patent application to possibly reside broadly in the extruder, wherein the extruder uses a modularly constructed supply housing.

A further feature or aspect of an exemplification is believed at the time of the filing of this patent application to possibly reside broadly in the extruder, wherein the extruder uses an induced draft on the external side of the filter, preferably a controllable induced draft.

Another feature or aspect of an exemplification is believed at the time of the filing of this patent application to possibly reside broadly in the extruder, wherein the extruder uses pressure surges for regenerating the filter disks when the filter performance decreases.

Yet another feature or aspect of an exemplification is believed at the time of the filing of this patent application to possibly reside broadly in the extruder, wherein the extruder uses an induced draft for each filter disk and by a controllable shut-off valve in each induced draft as well as a compressed air connection between shut-off valve and filter disk for pressure surges for the filter regeneration.

One feature or aspect of an exemplification is believed at the time of the filing of this patent application to possibly reside broadly in an extruder for processing feed material, such as plastic, rubber, powder coatings, or powdered chalk, said extruder comprising: an extruding section; a feed section configured to feed feed material into said extruding section; said extruding section comprising one of: (A) a single screw extruder comprising: a single-screw housing; and a single screw being disposed in said single-screw housing; (B) a planetary screw extruder comprising: a planetary housing comprising an inner toothing; a central spindle comprising an external toothing and being disposed in said planetary housing; planetary spindles, each comprising an external toothing and being disposed in said planetary housing; and said external toothing of said planetary spindles being configured to engage and mesh with said inner toothing of said planetary housing and said external toothing of said central spindle; and (C) a combination of first section comprising (A) and a second section comprising (B), wherein: the feed material is received in (A) and further processed in (B), or the feed material is received in (B) and further processed in (A); said feed section comprising a filter section disposed to filter carrier gas carrying feed material prior to the feeding of feed material into said extruding section; said filter section comprising at least two exhaust openings and at least two filter disks being disposed to cover said at least two exhaust openings; said at least two filter disks being configured to block the movement of feed material therethrough to minimize escape of feed material out through said at least two exhaust openings upon at least a portion of a carrier gas escaping out through said at least two exhaust openings; said at least two exhaust openings and said at least two filter disks being configured to permit the escape of at least a portion of a flow of carrier gas due to a pressure drop at said at least two filter disks, which portion is one of: more than 50% of a flow of carrier gas; more than 70% of a flow of carrier gas; more than 80% of a flow of carrier gas; and more than 90% of a flow of carrier gas; said at least two filter disks comprising a sintered material and a mean diameter of 10 to 50 millimeters or 20 to 40 millimeters; said at least two filter disks are uniformly distributed on the periphery of said filter section; and said extruding section being configured to permit exhaust of both carrier gas and additional gas or gases released during extrusion.

One feature or aspect of an exemplification is believed at the time of the filing of this patent application to possibly reside broadly in a method of processing feed material, such as plastic, rubber, powder coatings, or powdered chalk, in an extruder, said method comprising the steps of: feeding feed material from a feed section into an extruding section, which extruding section comprises one of (A), (B), and (C): (A) a single screw extruder comprising: a single-screw housing; and a single screw being disposed in said single-screw housing; (B) a planetary screw extruder comprising: a planetary housing comprising an inner toothing; a central spindle comprising an external toothing and being disposed in said planetary housing; planetary spindles, each comprising an external toothing and being disposed in said planetary housing; and said external toothing of said planetary spindles being configured to engage and mesh with said inner toothing of said planetary housing and said external toothing of said central spindle; and (C) a combination of first section comprising (A) and a second section comprising (B), wherein: the feed material is received in (A) and further processed in (B), or the feed material is received in (B) and further processed in (A); moving a flow of carrier gas carrying feed material into a filter section of said feed section, and filtering at least a portion of the flow of carrier gas prior to the feeding of feed material into said extruding section; covering at least two exhaust openings in said filter section using at least two filter disks, which said at least two filter disks comprise a sintered material and a mean diameter of 10 to 50 millimeters or 20 to 40 millimeters, and are uniformly distributed on the periphery of said filter section; blocking the movement of feed material through said at least two filter disks and thus minimizing escape of feed material out through said at least two exhaust openings upon at least a portion of the flow of carrier gas escaping out through said at least two exhaust openings; permitting the escape of at least a portion of the flow of carrier gas by dropping pressure at said at least two filter disks, which portion is one of: more than 50% of a flow of carrier gas; more than 70% of a flow of carrier gas; more than 80% of a flow of carrier gas; and more than 90% of a flow of carrier gas; and permitting exhaust of both carrier gas and additional gas or gases released during extrusion out of said extruding section.

The components disclosed in the patents, patent applications, patent publications, and other documents disclosed or incorporated by reference herein, may possibly be used in possible exemplifications of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one exemplification of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various exemplifications may be used with at least one exemplification or all of the exemplifications, if more than one exemplification is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications, patent publications, and other documents cited herein, and in the Declaration attached hereto, are hereby incorporated by reference as if set forth in their entirety herein except for the exceptions indicated herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, patent applications, patent publications, and other documents which are included in this application and which are referred to in paragraphs which state “Some examples of . . . which may possibly be used in at least one possible exemplification of the present application . . . ” may possibly not be used or useable in any one or more exemplifications of the application.

The sentence immediately above relates to patents, patent applications, patent publications, and other documents either incorporated by reference or not incorporated by reference.

All of the patents, patent applications, patent publications, and other documents, except for the exceptions indicated herein, which were cited in International Search Report dated Apr. 29, 2016, and/or cited elsewhere, as well as the International Search Report document itself, are hereby incorporated by reference as if set forth in their entirety herein except for the exceptions indicated herein, as follows: DE 10 2013 208 993, having the title “SCREW MACHINE AND METHOD AS WELL AS PROCESSING INSTALLATION FOR THE PROCESSING OF BULK MATERIAL”, published on Nov. 20, 2014; EP 1 977 877, having the title “Extruder”, published on Oct. 8, 2008; EP 2 218 568, having the title “Worm machine”, published on Aug. 18, 2010; CH 505 679, having the title “Vorrichtung zum Evakuieren einer Verarbeitungsmaschine und zum Einfüllen von teilchenförmigen oder stückigen Werkstoffen in die evakuierte Maschine”, published on Apr. 15, 1971; DE 22 51 425, having the title “Suction feed device for plastics granulates—in e.g. extruders with alternately cleaned filters on intake side of blower”, published on Apr. 25, 1974; U.S. Pat. No. 5,772,319, having the title “Material loader for injection molding press”, published on Jun. 30, 1998; and “Screens and Meshes” by Derek B Purchas ET AL., published in Derek B. Purchas and Ken Sutherland: “Handbook of Filter Media”, on Jan. 1, 2002; ISBN 978-1-85617-375-9.

The corresponding foreign and international patent publication applications, namely, Federal Republic of Germany Patent Application No. 10 2015 001 167.7, filed on Feb. 2, 2015, having inventor Harald RUST, and DE-OS 10 2015 001 167.7 and DE-PS 10 2015 001 167.7, and International Application No. PCT/EP2016/000077, filed on Jan. 17, 2016, having WIPO Publication No. WO 2016/124310 and inventor Harald RUST, are hereby incorporated by reference as if set forth in their entirety herein, except for the exceptions indicated herein, for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications, patent publications, and other documents, except for the exceptions indicated herein, are hereby incorporated by reference as if set forth in their entirety herein except for the exceptions indicated herein.

The corresponding foreign application, namely, Federal Republic of Germany Patent Application No. 10 2017 001 093, filed on Feb. 7, 2017, and DE-OS 10 2017 001 093 and DE-PS 10 2017 001 093, is hereby incorporated by reference as if set forth in its entirety herein, except for the exceptions indicated herein, for the purpose of correcting and explaining any possible misinterpretations of the English translation thereof. In addition, the published equivalents of the above corresponding foreign patent publication application, and other equivalents or corresponding applications, if any, in corresponding cases in the Federal Republic of Germany and elsewhere, and the references and documents cited in any of the documents cited herein, such as the patents, patent applications, patent publications, and other documents, except for the exceptions indicated herein, are hereby incorporated by reference as if set forth in their entirety herein except for the exceptions indicated herein.

The purpose of incorporating the corresponding foreign equivalent patent application(s), that is, PCT/EP2016/000077, German Patent Application 10 2015 001 167.7, and German Patent Application 10 2017 001 093 is solely for the purposes of providing a basis of correction of any wording in the pages of the present application, which may have been mistranslated or misinterpreted by the translator, and to provide additional information relating to technical features of one or more exemplifications, which information may not be completely disclosed in the wording in the pages of this application.

Statements made in the original foreign patent applications PCT/EP2016/000077, DE 10 2015 001 167.7 and DE 10 2017 001 093 from which this patent application claims priority which do not have to do with the correction of the translation in this patent application are not to be included in this patent application in the incorporation by reference.

Any statements about admissions of prior art in the original foreign patent applications PCT/EP2016/000077, DE 10 2015 001 167.7, and DE 10 2017 001 093 are not to be included in this patent application in the incorporation by reference, since the laws relating to prior art in non-U.S. Patent Offices and courts may be substantially different from the Patent Laws of the United States.

All of the references and documents cited in any of the patents, patent applications, patent publications, and other documents cited herein, except for the exceptions indicated herein, are hereby incorporated by reference as if set forth in their entirety herein except for the exceptions indicated herein. All of the patents, patent applications, patent publications, and other documents cited herein, referred to in the immediately preceding sentence, include all of the patents, patent applications, patent publications, and other documents cited anywhere in the present application.

Words relating to the opinions and judgments of the author of all patents, patent applications, patent publications, and other documents cited herein and not directly relating to the technical details of the description of the exemplifications therein are not incorporated by reference.

The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more exemplifications of the patents, patent applications, patent publications, and other documents, are not considered to be incorporated by reference herein for any of the patents, patent applications, patent publications, and other documents cited herein.

The description of the exemplification or exemplifications is believed, at the time of the filing of this patent application, to adequately describe the exemplification or exemplifications of this patent application. However, portions of the description of the exemplification or exemplifications may not be completely applicable to the claims as originally filed in this patent application, as amended during prosecution of this patent application, and as ultimately allowed in any patent issuing from this patent application. Therefore, any statements made relating to the exemplification or exemplifications are not intended to limit the claims in any manner and should not be interpreted as limiting the claims in any manner.

The details in the patents, patent applications, patent publications, and other documents cited herein may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the exemplification or exemplifications, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. § 1.72(b). As stated in 37 C.F.R. § 1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The exemplifications of the invention described herein above in the context of the preferred exemplifications are not to be taken as limiting the exemplifications of the invention to all of the provided details thereof, since modifications and variations thereof may be made without departing from the spirit and scope of the exemplifications of the invention.

What is claimed is:

1. An extruder for processing feed material, such as plastic, rubber, powder coatings, or powdered chalk, said extruder comprising:
an extruding section;
a feed section configured to feed feed material into said extruding section;
said extruding section comprising one of:
(A) a single screw extruder comprising:
a single-screw housing; and
a single screw being disposed in said single-screw housing;
(B) a planetary screw extruder comprising:
a planetary housing comprising an inner toothing;
a central spindle comprising an external toothing and being disposed in said planetary housing;
planetary spindles, each comprising an external toothing and being disposed in said planetary housing; and
said external toothing of said planetary spindles being configured to engage and mesh with said inner toothing of said planetary housing and said external toothing of said central spindle; and
(C) a combination of first section comprising (A) and a second section comprising (B), wherein:
the feed material is received in (A) and further processed in (B), or
the feed material is received in (B) and further processed in (A);
said feed section comprising a filter section disposed to filter carrier gas carrying feed material prior to the feeding of feed material into said extruding section;
said filter section comprising at least two exhaust openings and at least two filter disks being disposed to cover said at least two exhaust openings;
said at least two filter disks being configured to block the movement of feed material therethrough to minimize escape of feed material out through said at least two exhaust openings upon at least a portion of a carrier gas escaping out through said at least two exhaust openings;
said at least two exhaust openings and said at least two filter disks being configured to permit the escape of at least a portion of a flow of carrier gas due to a pressure drop at said at least two filter disks, which portion is one of:
more than 50% of a flow of carrier gas;
more than 70% of a flow of carrier gas;
more than 80% of a flow of carrier gas; and
more than 90% of a flow of carrier gas;
said at least two filter disks comprising a sintered material and a mean diameter of 10 to 50 millimeters or 20 to 40 millimeters;
said at least two filter disks are uniformly distributed on the periphery of said filter section; and
said extruding section being configured to permit exhaust of both carrier gas and additional gas or gases released during extrusion.

2. The extruder according to claim 1, wherein said feed section is configured to move feed material using air or a similar carrier gas, which feed material is made of finely-grained particles, granular particles, dusty particles, and/or fibers or the like that are sufficiently lightweight to be moved or carried by air or a similar carrier gas.

3. The extruder according to claim 2, wherein said at least two filters comprise metallic and/or non-metallic filter particles.

4. The extruder according to claim 3, wherein said filter section comprises a modular filter housing, such that the filter surface is modifiable by incorporating additional housing modules with additional filter housings or by removing housing modules.

5. The extruder according to claim 4, wherein said filter disks comprise a thickness of 0.5 to 4 millimeters or 1 to 3 millimeters.

6. The extruder according to claim 5, wherein said filter disks comprise pores, and the size of said pores, on the inflow surface of said filter disks, is smaller than either: the maximum size of the particles of the feed material, or the mean size of the particles of the feed material, or the smallest size of the particles of the feed material.

7. The extruder according to claim 6, wherein the size of said pores, on the inflow surface of said filter disks, is matched to a mean solid particle diameter of 0.001 to 0.5 millimeters or 0.03 to 0.4 millimeters.

8. The extruder according to claim 7, wherein the size of said pores increases with increased distance from the inflow surface.

9. The extruder according to claim 8, wherein said filter disks comprise multiple layers, which layers are either identical or different with respect to one another.

10. The extruder according to claim 9, wherein said filter disks comprise separately manufactured layers, or layers that have been sintered together.

11. The extruder according to claim 10, wherein at least two of said filter disks have the same shape, or at least two of said filter disks have different shapes, which shape is one of: round, angled, circular, oval, square, rectangular, or hexagonal.

12. The extruder according to claim 11, wherein said filter disks have the same or a different curvature than the wall of said filter housing or are flat, and said filter disks are adjustably held in said filter housing.

13. The extruder according to claim 12, wherein said filter disks are disposed flush with the inner surface of said filter housing or are set back from or recessed with respect to the inner wall of said filter housing, and said filter disks are held in a frame.

14. The extruder according to claim 13, wherein said feed section comprises a temperature control configured to control the temperature of said filter disks and/or said filter housing and/or said filter section, which temperature control is configured to utilize water, oil, air, or forced air from a fan.

15. The extruder according to claim 14, wherein said feed section comprises a stuffing screw arrangement configured to at least assist in feeding feed material into said extruding section.

16. The extruder according to claim 15, wherein said stuffing screw arrangement comprises either a single stuffing screw or two intermeshed stuffing screws, which stuffing screw arrangement is disposed to have a vertical or horizontal or inclined configuration.

17. The extruder according to claim 16, wherein said filter disks are configured to retain a layer of particles of feed material on the inflow surface of said filter disks, and said stuffing screw or stuffing screws are arranged at a distance from the inflow surface of said filter disks which is essentially equal to a desired thickness of the layer of particles of feed material on the inflow surface of said filter disks.

18. The extruder according to claim 17, wherein said feed section comprises a modular housing, and said feed section is configured to induce a controllable or constant draft on an external side of the filter.

19. The extruder according to claim 17, wherein said feed section comprises a pressure arrangement configured to generate pressure surges for regenerating said filter disks when the filter performance decreases, and wherein said feed section comprises a controllable shut-off valve for controlling a draft, and a compressed air connection between said shut-off valve and said filters disk to control pressure surges for the filter regeneration.

20. A method of processing feed material, such as plastic, rubber, powder coatings, or powdered chalk, in an extruder, said method comprising the steps of:
feeding feed material from a feed section into an extruding section, which extruding section comprises one of (A), (B), and (C):
(A) a single screw extruder comprising:
a single-screw housing; and
a single screw being disposed in said single-screw housing;
(B) a planetary screw extruder comprising:
a planetary housing comprising an inner toothing;
a central spindle comprising an external toothing and being disposed in said planetary housing;
planetary spindles, each comprising an external toothing and being disposed in said planetary housing; and
said external toothing of said planetary spindles being configured to engage and mesh with said inner toothing of said planetary housing and said external toothing of said central spindle; and
(C) a combination of first section comprising (A) and a second section comprising (B), wherein:
the feed material is received in (A) and further processed in (B), or
the feed material is received in (B) and further processed in (A);
moving a flow of carrier gas carrying feed material into a filter section of said feed section, and filtering at least a portion of the flow of carrier gas prior to the feeding of feed material into said extruding section;
covering at least two exhaust openings in said filter section using at least two filter disks, which said at least two filter disks comprise a sintered material and a mean diameter of 10 to 50 millimeters or 20 to 40 millimeters, and are uniformly distributed on the periphery of said filter section;
blocking the movement of feed material through said at least two filter disks and thus minimizing escape of feed material out through said at least two exhaust openings upon at least a portion of the flow of carrier gas escaping out through said at least two exhaust openings;
permitting the escape of at least a portion of the flow of carrier gas by dropping pressure at said at least two filter disks, which portion is one of:
more than 50% of a flow of carrier gas;
more than 70% of a flow of carrier gas;
more than 80% of a flow of carrier gas; and
more than 90% of a flow of carrier gas; and
permitting exhaust of both carrier gas and additional gas or gases released during extrusion out of said extruding section.
